(19) United States
(12) Patent Application Publication
(10) Pub. No.: US 2020/0224360 A1
(43) Pub. Date: Jul. 16, 2020

(54) FLAME RETARDANT KERATINOUS FIBRE

(71) Applicant: AUCKLAND UNISERVICES LIMITED, Auckland (NZ)

(72) Inventors: Debes BHATTACHARYYA, Auckland (NZ); Dae Seung JUNG, Auckland (NZ); Nam Kyeun KIM, Auckland (NZ)

(73) Assignee: AUCKLAND UNISERVICES LIMITED, Auckland (NZ)

(21) Appl. No.: 16/341,700

(22) PCT Filed: Oct. 16, 2017
(86) PCT No.: PCT/NZ2017/050135

§ 371 Date: Apr. 12, 2019

(30) Foreign Application Priority Data
Oct. 14, 2016 (NZ) 725259

(51) Int. Cl. D06M 11/70; D06M 13/332; D06M 13/328; D06M 13/358; D06M 11/59; D06M 11/55; C08J 5/06

(52) U.S. Cl. CPC D06M 11/70; D06M 13/332; D06M 13/328; D06M 2101/12; D06M 11/59; D06M 11/55; C08J 5/06; D06M 13/358

(57) ABSTRACT

The invention relates to a method of making a flame retardant material, and/or to a flame retardant material, and/or a polymer composite including the flame retardant material, and/or a method of making the polymer composite. More particularly, the invention relates to treatment of a keratinous fibre with a reactive amine and an inorganic acid to make a flame retardant material which is can be used in a polymer composite.

### FIELD OF INVENTION

The invention relates to a method of making a flame retardant material, and/or to a flame retardant material, and/or a polymer composite including the flame retardant material, and/or a method of making the polymer composite. More particularly, the invention relates to treatment of a keratinous fibre with a reactive amine and an inorganic acid to make a flame retardant material which is can be used in a polymer composite.

### BACKGROUND

Polymers have been reinforced with other fibres to produce polymer composites for many years. A well-known example is glass fibre reinforcement.

Polymer composites often include additives to enhance the properties of the composite. Flame retardancy, or resistance to combustion, is a critical issue in a broad range of applications of composites including use in the automobile industry, aircraft, building, and consumer products. There is therefore an increasing demand for flame retardant materials or materials that when formed into a composite can improve flame retardancy.

Halogenated flame retardants are presently widely used but they can produce toxic and corrosive chemical fumes during burning. There is a push from safety regulators to limit the usage of halogenated flame retardants or even to have them discontinued.

Natural fibres have attracted attention for use in polymer composites for their ability to provide good performance (for example improved strength) while being more environmentally friendly, sustainable and often lower, or at least competitive, cost. Such composites usually consist of a polymer matrix embedded with natural fibres. The most commonly used natural fibres are plant based materials such as wood, flax, hemp, bamboo etc. While natural fibre reinforcement has been shown to have many beneficial properties, the flame retardant properties of these composites have been of particular concern. These natural fibre composites therefore particularly benefit from flame retardant additives.

It is an object of the invention to provide a method of making a flame retardant material. Alternatively, it is an object to provide a flame retardant material. Alternatively, it is an object to provide a method of making a polymer composite having flame retardant properties.

Alternatively, it is an object to provide a polymer composite having flame retardant properties. Alternatively, it is an object of the invention to at least provide a useful choice to the public.

### SUMMARY OF THE INVENTION

According to a first aspect of the invention, there is provided a method of making a flame retardant material, the method including the steps of:
(i) treating a keratinous fibre with a reactive amine; and
(ii) treating the fibre with an inorganic acid.

wherein step (i) and (ii) can be done in either order.

Preferably step (ii) follows step (i).

Preferably the keratinous fibre is wool, hair, feather or silk. Preferably wool.

Preferably the reactive amine is selected from any one or more of: ammonia, C₁-C₂₀ alkylamines, amines with molecular mass between about 17-400 g/mol.

Preferably the reactive amine is selected from any one or more of: ethylenediamine, melamine, hexadecylamine, octadecylamine, dodecylamine, ammonia. Preferably ethylenediamine and/or melamine.

Preferably the reactive amine is in solution. More preferably the solution includes toluene and/or water. More preferably the solution includes water, i.e. is an aqueous solution.

Preferably the solution contains about 5 to 80% by weight reactive amine, preferably about 10 to 60% by weight reactive amine, preferably about 15 to 50% by weight reactive amine.

Preferably where the reactive amine is ethylenediamine the solution contains about 5 to 80 by weight ethylenediamine, preferably about 10 to 60% by weight ethylenediamine, preferably about 15 to 50% by weight ethylenediamine.

Preferably where the reactive amine is ethylenediamine the aqueous solution contains about 5 to 80% by weight, more preferably about 10 to 60% by weight, preferably about 15 to 50% by weight ethylenediamine.

Preferably where the reactive amine is melamine the solution contains about 1 to 30% by weight melamine, more preferably about 1 to 20% by weight melamine, preferably about 1 to 15% by weight melamine.

Preferably step (i) is at pH greater than 8. More preferably about 10 to 14.

Preferably the keratinous fibre in step (i) is immersed in the reactive amine for between about 5 minutes to 2 hours. More preferably for between about 10 minutes to 1 hour. More preferably between about 10 minutes to 40 minutes.

Preferably the reactive amine is warmed above room temperature. Preferably warmed to between about 35° C. and 90° C. Preferably warmed to between about 35° C. and 80° C. Preferably warmed to between about 35° C. and 60° C. More preferably about 50° C.

Preferably the fibre is removed from the reactive amine by filtration. Preferably the fibre is dried after step (i).

Preferably the inorganic acid provides a phosphate ion source. Preferably the inorganic acid is selected from phosphoric acid, pyrophosphoric acid and/or polyphosphoric acid. Preferably the inorganic acid is phosphoric acid.

Alternatively the inorganic acid is sulphur based. Preferably the inorganic acid provides a sulphate ion source. Preferably the inorganic acid is sulphuric acid.

Preferably the inorganic acid is in aqueous solution.

Preferably the inorganic acid solution contains about 1 to 75% by weight inorganic acid.

Preferably about 1 to about 50% by weight inorganic acid.

Preferably where the inorganic acid is phosphoric acid the aqueous solution contains about 1 to 75% by weight phosphoric acid. More preferably about 1 to 50% by weight phosphoric acid. More preferably about 5 to 40% by weight. More preferably about 10 to 35% by weight. More preferably about 10 to 30% by weight.

Preferably where the inorganic acid is sulphuric acid the aqueous solution contains about 1 to 30% by weight sulphuric acid. More preferably about 5 to 40% by weight. More preferably about 10 to 25% by weight.

Preferably the keratinous fibre is immersed in the inorganic acid for between about 1 minute to 1 hour. More preferably for between about 2 minutes to 40 minutes. More preferably between about 5 minutes to 30 minutes. Preferably about 10 minutes.

Preferably the inorganic acid and keratinous fibre are warmed above room temperature. Preferably between about 35° C. and 80° C. More preferably about 60° C.

Preferably the molar ratio of reactive amine to inorganic acid used in steps (i) and (ii) is between about 0.01 to 50. More preferably about 1.5 to 30. More preferably about 1.5 to 25. More preferably about 2 to 20.

Preferably the keratinous fibre is removed from the inorganic acid by filtration. Preferably the keratinous fibre is dried. Preferably the fibre is rinsed with a solvent.

Preferably the fibre is also treated with a char forming agent. Preferably the char forming agent is added in step (ii). Preferably the char forming agent is selected from a polyol. Preferably the char forming agent is selected from pentaerythritol monomer, pentaerythritol dimer, pentaerythritol trimer, a phenol-formaldehyde resin, methylol melamine, starch, dextrin, sorbitol. Preferably the char forming agent is pentaerythritol monomer.

Preferably the method further includes the step of combining at least one synthetic polymer with the keratinous fibre followings steps (i) and (ii) to form a composite material.

According to a second aspect of the invention, there is provided a flame retardant material produced by the method of the first aspect.

According to a third aspect of the invention, there is provided a flame retardant material including:

keratinous fibre including between about 1 and 40% by weight above natural levels of phosphorus or sulphur.

Preferably the phosphorus or sulphur is substantially distributed throughout the cross section of the keratinous fibre.

Preferably the phosphorus or sulphur is substantially evenly distributed throughout the cross section of the keratinous fibre.

Preferably the keratinous fibre includes between about 2 and 40% by weight phosphorus. More preferably the keratinous fibre includes between about 3 and 40% by weight phosphorus, preferably between about 5 and 40% by weight phosphorus, preferably between about 7 and 40% by weight phosphorus, preferably between about 10 and 40% by weight phosphorus, preferably between about 15 and 40% by weight phosphorus. Alternatively, between about 1 and 30% by weight phosphorus, more preferably between about 1 and 25% by weight phosphorus, more preferably between about 15 and 25% by weight phosphorus.

Preferably at least a portion of the phosphorus is in the form of an amine phosphate.

Preferably the keratinous fibre includes between about 6 and 45% by weight sulphur. More preferably between about 7 and 45% by weight sulphur, preferably between about 10 and 45% by weight sulphur, preferably about 15 and 40% by weight sulphur. Alternatively between about 15 and 25% sulphur.

Preferably the keratinous fibre is wool, hair, feather or silk. Preferably wool.

Preferably the fibre includes a char forming agent. Preferably the char forming agent is a polyol. Preferably the char forming agent is selected from pentaerythritol monomer, pentaerythritol dimer, pentaerythritol trimer, a phenol-formaldehyde resin, methylol melamine, starch, dextrin, sorbitol. Preferably the char forming agent is a pentaerythritol monomer.

According to a fourth aspect of the invention, there is provided a flame retardant material including:
keratinous fibre including between about 1 and 40% by weight phosphorus.

Preferably wherein the phosphorus is substantially distributed throughout the cross section of the keratinous fibre.

Preferably the phosphorus is substantially evenly distributed throughout the cross section of the keratinous fibre.

Preferably the keratinous fibre includes between about 2 and 40% by weight phosphorus, preferably between about 3 and 40% by weight phosphorus, preferably between about 5 and 40% by weight phosphorus, preferably between about 7 and 40% by weight phosphorus, preferably between about 10 and 40% by weight phosphorus, preferably between about 15 and 40% by weight phosphorus. Alternatively, between about 1 and 30% by weight phosphorus, preferably between about 1 and 25% by weight phosphorus, preferably between about 15 and 25% by weight phosphorus.

Preferably at least a portion of the phosphorus is in the form of an amine phosphate.

Preferably the keratinous fibre is wool, hair, feather or silk. Preferably wool.

Preferably the fibre includes a char forming agent. Preferably the char forming agent is a polyol. Preferably the char forming agent is selected from pentaerythritol monomer, pentaerythritol dimer, pentaerythritol trimer, a phenol-formaldehyde resin, methylol melamine, starch, dextrin, sorbitol. Preferably the char forming agent is a pentaerythritol monomer.

According to a fifth aspect of the invention, there is provided a flame retardant material including:
keratinous fibre including between about 5 and 45% by weight sulphur.

Preferably wherein the sulphur is substantially distributed throughout the cross section of the keratinous fibre.

Preferably the sulphur is substantially evenly distributed throughout the cross section of the keratinous fibre.

Preferably the keratinous fibre includes between about 5 and 45% by weight sulphur. More preferably between about 7 and 45% by weight sulphur, preferably between about 10 and 45% by weight sulphur, preferably about 15 and 45% by weight sulphur. Alternatively between about 15 and 25% sulphur.

Preferably the keratinous fibre is wool, hair, feather or silk. Preferably wool.

Preferably the fibre includes a char forming agent. Preferably the char forming agent is a polyol. Preferably the char forming agent is selected from pentaerythritol monomer, pentaerythritol dimer, pentaerythritol trimer, a phenol-formaldehyde resin, methylol melamine, starch, dextrin, sorbitol. Preferably the char forming agent is a pentaerythritol monomer.

According to a sixth aspect of the invention, there is provided a method of making a polymer composite, the method including the steps:
(i) treating a keratinous fibre with a reactive amine; and
(ii) treating the fibre with an inorganic acid;
(iii) combining at least one synthetic polymer with the fibre.

wherein step (i) and (ii) can be done in either order then followed by step (iii).

Preferably step (ii) follows step (i).

Preferably the keratinous fibre is wool, hair, feather or silk. Preferably wool.

Preferably the reactive amine is selected from any one or more of: ammonia, C₁-C₂₀ alkylamines, amines with molecular mass between about 17-400 g/mol.

Preferably the reactive amine is selected from any one or more of: ethylenediamine, melamine, hexadecylamine, octadecylamine, dodecylamine, ammonia. Preferably ethylenediamine and/or melamine.

Preferably the reactive amine is in solution. More preferably the solution includes toluene and/or water. More preferably the solution includes water, i.e. is an aqueous solution.

Preferably where the reactive amine is ethylenediamine the aqueous solution contains about 5 to 80% by weight ethylenediamine, more preferably about 10 to 60% by weight, preferably about 15 to 50% by weight.

Preferably where the reactive amine is melamine the solution contains about 1 to 30% by weight melamine, more preferably about 1 to 20% by weight, preferably about 1 to 15% by weight.

Preferably step (i) is at pH greater than 8. More preferably about 10 to 14.

Preferably the keratinous fibre in step (i) is immersed in the reactive amine for between about 5 minutes to 2 hours. More preferably for between about 10 minutes to 1 hour. More preferably between about 10 minutes to 40 minutes.

Preferably the reactive amine is warmed above room temperature. Preferably warmed to between about 35° C. and 90° C. Preferably warmed to between about 35° C. and 80° C. Preferably warmed to between about 35° C. and 60° C. More preferably about 50° C.

Preferably the fibre is removed from the reactive amine by filtration. Preferably the fibre is dried after step (i).

Preferably the inorganic acid provides a phosphate ion source. Preferably the inorganic acid is selected from phosphoric acid, pyrophosphoric acid and/or polyphosphoric acid. Preferably the inorganic acid is phosphoric acid.

Alternatively the inorganic acid is sulphur based. Preferably the inorganic acid provides a sulphate ion source. Preferably the inorganic acid is sulphuric acid.

Preferably the inorganic acid is in aqueous solution.

Preferably the inorganic acid solution contains about 1 to 75% by weight inorganic acid. Preferably about 1 to about 50% by weight inorganic acid.

Preferably where the inorganic acid is phosphoric acid the aqueous solution contains about 1 to 75% by weight phosphoric acid. More preferably about 1 to 50% by weight phosphoric acid.

More preferably about 5 to 40% by weight. More preferably about 10 to 30% by weight.

Preferably where the inorganic acid is sulphuric acid the aqueous solution contains about 1 to 30% by weight sulphuric acid. More preferably about 5 to 40% by weight. More preferably about 10 to 25% by weight.

Preferably the keratinous fibre is immersed in the inorganic acid for between about 1 minute to 1 hour. More preferably for between about 2 minutes to 40 minutes. More preferably between about 5 minutes to 30 minutes. Preferably about 10 minutes.

Preferably the inorganic acid and keratinous fibre are warmed above room temperature. Preferably between about 35° C. and 80° C. More preferably about 60° C.

Preferably the molar ratio of reactive amine to inorganic acid used in steps (i) and (ii) is between about 0.01 to 50. More preferably about 1.5 to 30. More preferably about 1.5 to 25. More preferably about 2 to 20.

Preferably the keratinous fibre is removed from the inorganic acid by filtration. Preferably the keratinous fibre is dried. Preferably the fibre is rinsed with a solvent.

Preferably the fibre is also treated with a char forming agent. Preferably the char forming agent is added in step (ii). Preferably the char forming agent is selected from a polyol. Preferably the char forming agent is selected from pentaerythritol monomer, pentaerythritol dimer, pentaerythritol trimer, a phenol-formaldehyde resin, methylol melamine, starch, dextrin, sorbitol. Preferably the char forming agent is a pentaerythritol monomer.

Preferably the synthetic polymer and the fibre are combined by mixing and/or blending and/or melting.

Preferably the fibre is pulverised prior to step (iii).

Preferably the synthetic polymer is a thermoset or a thermoplastic polymer.

Preferably the thermoplastic polymer is polypropylene, polyethylene, polyvinyl chloride, polyester, and/or polystyrene. Preferably polyethylene or polypropylene. Preferably the thermoset polymer is epoxy resin, unsaturated vinyl ester, polyester resins, vinyl ester resins, phenolic and/or urethane.

Preferably in step (iii) about 1 to 80% by weight keratinous fibre is combined with about 20 to 99% by weight synthetic polymer. More preferably between about 1 and 60% by weight fibre with about 40 to 99% by weight synthetic polymer. More preferably between about 10 and 60% by weight fibre with about 40 to 90% by weight synthetic polymer.

Preferably following step (iii) the polymer composite is formed into a desired shape.

Optionally one or more additional components are added in step (iii). Optional additional components include a compatibilizer and/or reinforcement.

According to a seventh aspect of the invention, there is provided a polymer composite produced by the method of the sixth aspect.

According to an eighth aspect of the invention, there is provided a polymer composite including:
a keratinous fibre,
at least one synthetic polymer,

wherein the keratinous fibre includes between about 1 and 40% by weight above natural levels of phosphorus or sulphur.

Preferably the phosphorus or sulphur is substantially distributed throughout the cross section of the keratinous fibre.

Preferably the phosphorus or sulphur is substantially evenly distributed throughout the cross section of the keratinous fibre.

Preferably the keratinous fibre includes between about 2 and 40% by weight phosphorus. More preferably the keratinous fibre includes between about 5 and 40% by weight phosphorus, preferably about 7 and 40% by weight phosphorus, preferably about 10 and 40% by weight phosphorus, preferably about 15 and 40% by weight phosphorus. Alternatively, about 1 and 30% by weight phosphorus, more preferably between about 1 and 25% by weight phosphorus, more preferably between about 15 and 25% by weight phosphorus.

Preferably at least a portion of the phosphorus is in the form of an amine phosphate.

Preferably the keratinous fibre includes between 6 and 456% by weight sulphur. More preferably between about 6 and 45% by weight sulphur, preferably between about 10 and 45% by weight sulphur, preferably about 15 and 40% by weight sulphur. preferably between about 15 and 25% sulphur.

Preferably the keratinous fibre is wool, hair, feather or silk. Preferably wool.

Preferably the fibre includes a char forming agent. Preferably the char forming agent is a polyol. Preferably the char forming agent is selected from pentaerythritol monomer, pentaerythritol dimer, pentaerythritol trimer, a phenol-formaldehyde resin, methylol melamine, starch, dextrin, sorbitol. Preferably the char forming agent is pentaerythritol monomer.

Preferably the synthetic polymer is a thermoset or a thermoplastic.

Preferably the thermoplastic is polypropylene, polyethylene, polyvinyl chloride, polyester and/or polystyrene. Preferably polypropylene and/or polyethylene. Preferably the thermoset polymer is epoxy resin, unsaturated vinyl ester, polyester resins, vinyl ester resins, phenolic and/or urethane.

Preferably the composite includes about 1 to 80% by weight keratinous fibre, more preferably between about 1 and 60% by weight, more preferably between about 10 and 60% by weight.

Preferably the composite includes about 1 to 80% by weight keratinous fibre combined with about 20 to 99 to 20% by weight synthetic polymer. More preferably between about 1 and 60% by weight fibre with about 40 to 99 to 40% by weight synthetic polymer. More preferably between about 10 and 60% by weight fibre with about 40 to 90 to 40% by weight synthetic polymer.

According to an ninth aspect of the invention, there is provided a polymer composite including:
a keratinous fibre,
at least one synthetic polymer,

wherein the keratinous fibre includes between about 1 and 40% by weight phosphorus.

According to tenth aspect of the invention, there is provided a polymer composite including:
a keratinous fibre,
at least one synthetic polymer,

wherein the keratinous fibre includes between about 1 and 40% by weight sulphur.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be in any sense limiting.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

Embodiments of the invention will now be described, by way of example only, with reference to the accompanying drawings in which:

FIG. 1 shows a FT-IR spectra comparing untreated wool and IFR wool of the invention;

FIG. 2 shows SEM images comparing of the fibres of the untreated wool and treated wool;

FIG. 3 shows the distribution of phosphorus, nitrogen, oxygen, carbon and sulphur through a cross section of treated wool fibre;

FIG. 4 shows SEM images of the fibres of the untreated wool (for comparison);

FIG. 5 shows SEM images of the fibres of the treated wool;

FIG. 6 shows the results from a cone calorimeter measuring the heat release rate of polypropylene compared to a treated wool fibre/polypropylene composite of the invention;

FIG. 7 shows results from a cone calorimeter measuring the heat release rate of polypropylene (comparison), untreated 40% wool fibre/polypropylene composite (comparison), 40% treated wool/polypropylene/maleic anhydride grafted polypropylene composite of the invention, and 20% Ammonium Polyphosphate/polypropylene composite (comparison).

FIG. 8 shows test of mechanical properties of pure polypropylene (comparison) 40% treated wool/polypropylene/maleic anhydride grafted polypropylene composite of the invention and ammonium polyphosphate/polypropylene composite (comparison).

FIG. 9 shows SEM image of the wool fibre treated with melamine/phosphoric acid/pentaerythritol;

FIG. 10 shows Fourier transform infrared spectroscopy (FT-IR) spectra of untreated wool (wool), phosphoric acid treated wool (PA wool), flame retardant wool of the invention (FR wool—treated with phosphoric acid then ethylenediamine) and ethylenediamine phosphate (EDAP) for comparison.

FIG. 11 shows thermo gravimetric analyser (TGA) curves of untreated wool fibre (wool), phosphoric acid treated wool (PA wool) and flame retardant wool of the invention (FR wool—treated with phosphoric acid then ethylenediamine);

FIG. 12 shows a plot of content of phosphoric acid (PA) in PA treated wool as a function of the concentration of the phosphoric acid used.

FIG. 13 shows the content of ethylenediamine in flame retardant wool of the invention. The wool was treated using 32% phosphoric acid (PA) followed by various concentrations of ethylaminediamine (EDA).

FIG. 14 shows comparative SEM image of the surface of untreated wool;

FIG. 15 shows SEM images of the surface and cross section of treated wool fibres. FIG. 15A shows wool treated with phosphoric acid. FIG. 15B shows wool fibre treated with 32% phosphoric acid and followed by ethylenediamine (EDA) in a 3.6 EDA/PA molar ratio. FIG. 15C shows wool fibre treated with 32% phosphoric acid followed by ethylenediamine (EDA) in a 18.8 EDA/PA molar ratio;

FIG. 16 shows a SEM image of pulverised flame retardant wool of the invention that was treated with 32% phosphoric acid followed by ethylenediamine (EDA) in a 18.8 EDA/PA molar ratio;

FIG. 17 shows the results of the burning test for (A) pure polypropylene (PP) (comparison), (B) 40% untreated wool/polypropylene (PP) (comparison), (C) 40% treated wool (flame retardant wool—FR wool)/polypropylene (PP) of the invention and (D) 20% APP/PP (comparison). FIG. 18 shows the results of the cone calorimeter test for (A), (B), (C) and (D).

### DETAILED DESCRIPTION OF PREFERRED EMBODIMENTS

The invention provides a flame retardant material and/or a method of making a flame retardant material based on a treated keratinous fibre. The invention also or alternatively provides a polymer composite and/or a method of making a polymer composite including a treated keratinous fibre which improves the flame retardancy of the composite.

In general terms, the inventors have found a keratinous fibre (for example wool) can be treated with a reactive amine and an inorganic acid to produce a flame retardant material.

The flame retardant materials of the invention are particularly useful for use in producing natural fibre polymer composites by combining (e.g. by mixing and/or blending and/or melting) the fibre with a polymer. However, it is envisioned that the fibre could also be used for other purposes or sold as a product in its own right for later use. The inventors have shown the brittleness/flexibility of the flame retardant materials can be modified by using different reagents and/or different concentrations of reagents to treat the fibre. The brittleness of the treated fibre can affect the mechanical properties of a composite made with the treated fibre. If the keratinous fibres are treated in a manner to allow them to still be in relatively flexible fibre form, they can add strength to a composite, Alternatively, the keratinous fibres can be treated such that they become brittle and can be pulverized to power form. In this state the flame retardant material of the invention can be incorporated into composites as a flame retardant additive in a similar manner to existing flame retardant additives, such as halogenated flame retardants. In general, the inventors have found brittleness in the fibres to be beneficial, as it allows for the fibres to be easily broken down into powder form. The powder form helps the material to achieve a substantially uniform dispersion through a polymer material when forming a composite thus imparting the beneficial properties of the treated fibre (e.g. flame retardancy) to the composite.

Alternatively, control of the brittleness/flexibility of the fibres means more flexible fibres can be produced which can be used for other purposes, for example inclusion in fabrics or as fillers or pads as desired.

The method of making a flame retardant material includes two primary steps: (i) treating a keratinous fibre (for example wool) with a reactive amine; and (ii) treating the fibre with an inorganic acid. The steps can be done in any order. However, they are preferably done step (i) first followed by step (ii).

While steps (i) and (ii) will usually follow each other in a substantially continuous manner, it is of course possible for the process to be discontinuous and for the reactive amine treated keratinous fibre to produced and then stored and/or transported for later treatment with the inorganic acid. The invention will therefore extend to the reactive amine treated keratinous fibre as a product in and of itself which can be used in the production of the flame retardant keratinous material. The reactive amine treated keratinous fibre having the amine dispersed through the cross-section of the fibre. If step (i) follows step (ii) then the invention extends to the inorganic acid treated keratinous fibre in a similar manner.

While not wishing to be bound by theory, it is believed in step (i), the fibre is modified with reactive amine, allowing the reactive amine to diffuse into the fibre. In step (ii), the inorganic acid infiltrates through the fibre. It is believed the steps produce two separated regions, an acid absorbed region in the middle of the cross section of the fibre and a layer around the outside of the cross section of the fibre resulting from the reaction between the acid and the reactive amine. The inventors believe when step (i) is done first the reactive amine acts on the scale like surface of the fibre allowing the inorganic acid to more readily infiltrate through to the core of the fibre. For example, the inventors have shown where ethylenediamine followed by phosphoric acid were used to treat wool fibre; phosphorus was distributed throughout the cross section of the treated wool fibre. Distribution was also substantially uniform. The inventors have also shown evidence that ethylenediamine phosphate may be formed in the fibre when the fibre is treated with phosphoric acid (the inorganic acid) and ethylenediamine (the reactive amine).

The inventors believe the method of the invention provides a stronger bond between the keratinous fibre and flame retardant ingredients (reactive amine and inorganic acid), compared to other surface coating techniques. The inventors consider such well integrated flame retardant ingredients which should not be mechanically separable from the fibre are particularly useful. For example the fibres can be ground or processed without substantially losing their flame retardant properties allowing those properties to be transferred to compounds formed using the treated fibres.

The keratinous fibre is preferably an animal derived product, for example wool, silk, feathers. In a preferred embodiment the keratinous fibre is wool, as this is a readily available, relatively cheap product. Advantageously, wool is naturally relatively flame retardant, for example compared to other natural fibres such as wood, or cotton. However, the natural flame retardancy is not sufficient for many applications, particularly when formed into a polymer composite. For applications where a relatively brittle fibre is required (for example use in composites) short fibres in a powder form can be used in the invention. Wool is available in many grades based on fibre length and thickness. A particular advantage of the present invention is that coarse and short fibres (for example less than 3 mm) of wool can be used which are relatively cheap. These are sometimes seen as waste products in which case the invention is of particular advantage as it provides a commercial application for these products. The wool preferably goes through a scouring process prior to use in the invention in order to generally remove contaminants and to remove much of the lanolin. However, this is not believed to be essential. In addition, recycled wool can be used which usually has limited commercial value.

A reactive amine is used in the invention to treat the keratinous fibre. Examples of reactive amines include ammonia, C₁-C₂₀ alkylamines, amines with molecular mass between about 17 and 400 g/mol Examples include: ethylenediamine, melamine, hexadecylamine, octadecylamine, dodecylamine, and/or ammonia, although others can be used. A preferred reactive amine is ethylenediamine or melamine. Combinations of such amines may also be used.

When used in the treatment step the reactive amine is preferably in solution rather than being used neat. Most preferably it is an aqueous solution, which is easy to handle and less toxic. An alternative relatively inert solvent is toluene. The amine solution preferably contains about 5 to 80% by weight reactive amine, preferably about 10 to 60% by weight reactive amine, preferably about 15 to 50% by weight reactive amine. The concentration of the solution will be dependent on the reactive amine used and if the amine treatment is after the inorganic acid treatment, the amount of acid in the keratinous fibre to react with the amine. However, for example, where the reactive amine is ethylenediamine the solution is preferably about 5 to 80% by weight ethylenediamine, preferably about 10 to 60% by weight ethylenediamine, preferably about 15 to 50% by weight ethylenediamine. As another example, where aqueous ethylenediamine solution is used the solution is preferably between about 5 to 80% by weight ethylenediamine, more preferably about 10 to 60% by weight ethylenediamine, most preferably about 15 to 50% by weight ethylenediamine. As another example, where aqueous melamine is used the solution is preferably between about 1 to 30% by weight melamine, more preferably about 1 to 20% by weight, most preferably about 1 to 15% by weight. Alternatively, the amount of solvent is selected to ensure the keratinous fibre is immersed.

The pH of the treatment step when using an aqueous solution will also be dependent on the reactive amine used. However, the pH is preferably greater than 8, more preferably about 10 to 14. If the pH is not naturally above 8 (due to the type and concentration of the reactive amine) a base such as NaOH or KOH or the like can be used to adjust the pH. Such matters would be well known to the skilled person. While not wishing to be bound by theory, the inventors believe the higher pH levels help to soften or swell the outer scale-like surface of the keratinous fibre to help the reactive amine to enter the fibre.

The treatment step using the reactive amine preferably involves immersing the keratinous fibre in the reactive amine for a period of time. In this case, an aqueous solution is a particularly useful for handling purposes. The keratinous fibre is preferably immersed in the reactive amine for between about 5 minutes to 2 hours, more preferably for between about 10 minutes to 1 hour, more preferably between about 10 minutes to 40 minutes (either in concentrated reactive amine or a solution). In addition, the reactive amine is preferably warmed above room temperature, for example warmed to between about 35° C. and 90° C., preferably to between about 35° C. and 80° C., preferably to between about 35° C. and 60° C., preferably about 50° C. While immersing is a convenient option, it will be apparent to the skilled person that other options are available, such as spraying the reactive amine on the keratinous fibre.

If needed the fibre may be filtered and/or dried after step (i). Filtration may be achieved by vacuum filtration prior to drying, but a person skilled in the art would be aware of other options. Preferably the fibre is dried at between about 75 and 120° C., more preferably about 110° C. An oven or environmental chamber or the like can be used for drying.

The inorganic acid used in the invention preferably provides a phosphate ion or is sulphur based, preferably providing a sulphate ion source. Other inorganic acids can be used, for example hydrochloric acid, hydrofluoric acid, hydrobromic acid, perchloric acid, hydroiodic, boric acid, nitric acid. However, acids which provide halide ions are less preferred because although halogenated flame retardants are presently widely used but they can produce toxic and corrosive chemical fumes during burning. There is a push from safety regulators to limit the usage of halogenated flame retardants or even to have them discontinued. Other inorganic acids, for example boric acid and nitric acid tend to be very toxic or highly corrosive, so pose difficulties for handling and again produce potentially toxic fumes.

The most preferred inorganic acid for use in the invention provides a phosphate ion source, for example phosphoric acid, pyrophosphoric acid and/or polyphosphoric acid. The inventors have found phosphoric acid to be particularly useful in the invention and relatively easy to handle because it is classified as being a relatively weak acid and so less corrosive than other acids. Phosphoric acid is also less toxic and more bio-compatible compared to other acids. These issues are of particular of concern when considering large scale production and use.

An alternative inorganic acid for use in the invention is sulphur based and/or provides a sulphate ion source, for example sulphuric acid or sulphonic. However, sulphuric acid is a relatively strong acid than phosphoric acid, so is more difficult to handle.

The treatment step using the inorganic acid preferably involves immersing the keratinous fibres in the inorganic acid. In this case, again an aqueous solution is a particularly useful for handling purposes although other solvents could be used such as ethanol, THF or DMF. The concentration of the solution will be partially dependant on the inorganic acid used; however, generally the inorganic acid solution preferably contains about 1 to 75% by weight inorganic acid, preferably about 1 to about 50% by weight inorganic acid. Benefits of volatile solvent use may be to reduce the need for filtration/drying however.

As an example, where the inorganic acid is phosphoric acid the aqueous solution preferably contains about 1 to 75% by weight phosphoric acid, preferably about 1 to 50% by weight phosphoric acid, more preferably about 5 to 40% by weight, more preferably about 10 to 35% by weight, more preferably about 10 to 30% by weight. As a further example, where the inorganic acid is sulphuric acid the aqueous solution preferably contains about 1 to 30% by weight sulphuric acid, more preferably about 5 to 40% by weight, more preferably about 10 to 25% by weight.

The keratinous fibre is preferably immersed in the inorganic acid for between about 1 minute to 1 hour, more preferably for between about 2 minutes to 40 minutes, more preferably between about 5 minutes to 30 minutes, most preferably 10 minutes (either in concentrated inorganic acid or a solution). In addition, the inorganic acid is preferably warmed above room temperature, for example to between about 35° C. and 80° C., more preferably about 60° C.

Again particularly when there is immersion in an aqueous solution, the fibre is preferably filtered and/or dried and/or rinsed with a solvent after step (ii). The fibre can optionally be rinsed with a volatile solvent, for example tetrahydrofuran (THF) to aid drying and/or remove excess reagents. Preferably the fibre (although it may resemble power/precipitate at this point) is dried above 100° C. to remove moisture, preferably at about 110° C. The fibre can be dried for several hours, for example 3 hours, but this will be dependent on the quantity of fibre and other factors that are within the judgement of a person skilled in the art.

The amount of reactive amine and inorganic acid used in the treatment steps (i) and (ii) can be selected based on the molar ratio of the reactive amine to inorganic acid. The molar ratio used in steps (i) and (ii) is preferably between about 0.01 to 50, more preferably about 1.5 to 30. more preferably about 1.5 to 25, more preferably about 2 to 20. The amount of the reactive amine or organic acid incorporated into the keratinous fibre in the first treatment step (either step (i) or step (ii) depending on which order they are done in) can be measured, for example by weighting the keratinous fibre prior to and after treatment, then calculating the molar amount of reactive amine or organic acid (as required) for use in the second step.

The fibre can optionally also be treated with a char forming agent which aids in the formation of a char. Preferably the char forming agent is added in step (ii) but can be added in step (i). Preferably the char forming agent is a polyol, for example any one or more of pentaerythritol monomer, pentaerythritol dimer, pentaerythritol trimer, methylol melamine, starch, a phenol-formaldehyde resin, starch, dextrin, sorbitol. A preferred polyol is pentaerythritol monomer.

As discussed previously, the inorganic acid for use in the invention preferably provides phosphate ions or is sulphur based. The inventors have shown the flame retardant material has the elements associated with the anions embedded through the keratinous fibre. An aspect of the invention is therefore a flame retardant material including keratinous fibre including between 1 and 40% by weight above natural levels of phosphorus or sulphur. An alternative aspect of the invention is a flame retardant material including keratinous fibre including between 1 and 40% by weight above natural levels of phosphorus or sulphur, wherein natural levels are the amount of phosphorus or sulphur in the keratinous fibre prior to treatment for flame retartancy. The phosphorus or sulphur is preferably substantially distributed throughout the cross section of the keratinous fibre. It is particularly surprising that the elements have been shown to distribute throughout the cross section rather than as a layer at the surface. This property allows the material to be put into a powder form and to transfer the property to materials it is incorporated into. The flame retardant material therefore preferably includes a keratinous fibre including between about 1 and 40% by weight phosphorus, more preferably between about 2 and 40% by weight phosphorus. Preferably the phosphorus is substantially evenly distributed throughout the cross section of the keratinous fibre. Phosphorous naturally occurs in only very low levels in the keratinous fibre (e.g. below 1%). Preferably at least a portion of the phosphorus is in the form of an amine phosphate. Alternatively, the flame retardant material preferably includes a keratinous fibre including between about 5 and 40% by weight sulphur, more preferably between about 6 and 40% by weight sulphur. Preferably the sulphur is substantially evenly distributed throughout the cross section of the keratinous fibre. Sulphur naturally occurs in the keratinous fibre at levels approximately below 5%. It is considered that if other inorganic acids were used the relevant elements from the anion would also distribute throughout the cross section of the keratinous fibre. However, as noted above inorganic acids which provide a phosphate ion or sulphate ion (for example phosphoric acid or sulphuric acid) are preferred for use in the invention.

As previously noted a preferred use of the flame retardant material of the invention is in polymer composites to improve flame retardancy of the polymer and/or improve mechanical properties.

An aspect of the invention is therefore a method of making a polymer composite, the method including the steps: (i) treating a keratinous fibre with a reactive amine; (ii) treating the fibre with an inorganic acid (wherein steps (i) and (ii) can be done in either order); then (iii) combing at least one synthetic polymer with the fibre.

Steps (i) and (ii) were previously discussed above.

The treated keratinous fibre is preferably pulverised to a powder prior to combing with the synthetic polymer to aid in even distribution of the fibre throughout the composite. A preferred particle size is below 200 micrometre. A pestle and mortar can be used to grind the treated fibre. A grinding machine (for example a ball mill grinder) or the like could be used for higher volumes.

The flame retardant material of the invention in powder form is combined with a synthetic polymer by mixing and/or blending and/or melting the synthetic polymer. The mixing/blending times and temperatures will be dependent on the synthetic polymer(s) used and will be within the knowledge of a person skilled in the art. However for example, the inventors have shown the treated fibre can be combined with polypropylene (PP) and maleic anhydride grafted polypropylene by blending at 170° C. for 3 min at a speed of 50 rpm in a Brabender mixer. The composite can then be formed into a shape of choice, for example the inventors used a hot press to form sheets. Other thermoset or thermoplastic polymers can be used. The preferred synthetic polymer is polypropylene and/or polyethylene. Examples of other synthetic polymers include polyethylene, polyvinyl chloride, polyester, polystyrene, epoxy resin, unsaturated vinyl ester, polyester resins, vinyl ester resins, phenolic resins and/or urethane. Modified polymer options can also be used such as maleic anhydride grafted polypropylene. Other thermoset and thermoplastic polymers that may be used will be known to a person skilled in the art.

Preferably to make the composite about 1 to 80% by weight of treated keratinous fibre is combined with about 20 to 99% by weight synthetic polymer. More preferably between about 1 and 60% by weight fibre with about 40 to 99% by weight synthetic polymer. More preferably between about 10 and 60% by weight fibre with about 40 to 90% by weight synthetic polymer. The choice of proportions will be in part be dictated by the mechanical properties required in the composite.

Optionally the composites of the invention can include additional components which are preferably added in step (iii). For example, additional components can include a compatibilizer (for example maleic anhydride) and/or reinforcement (for example (nano) silicate, glass fibre, carbon fibre). The amounts of the others components would be dependent on their purpose and nature. As an example the composites of the invention optionally include about 1 to 10% by weight of a compatibilizer and/or about 1 to 70% by weight of reinforcement.

Further aspect of the invention is to provide a polymer composite including: a keratinous fibre, at least one synthetic polymer, wherein the keratinous fibre includes between about 1 and 40% by weight above natural levels of phosphorus or sulphur; wherein the phosphorus or sulphur is distributed (preferably substantially evenly distributed) throughout the cross section of the keratinous fibre. The keratinous fibre of the invention was previously discussed above along with the process of combining it with a synthetic polymer to produce a polymer composite

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Wherein the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the scope of the invention.

### EXAMPLES

### Example 1.1

Scoured wool was treated to give intumescent flame retardant (IFR) properties according to the invention. Chopped coarse wool fibre (mean fibre length: 2.4 mm) was immersed in 30 wt % aqueous ethylenediamine solution for 20 min at 50° C., then vacuum filtered and dried at 110° C. for 30 min. Aqueous solution composed of phosphoric acid (PA) (18 wt %) and pentaerythritol monomer (PER) (weight ratio phosphoric acid to pentaerythritol 3:1), was prepared, then the treated wool was added to the PA/PER solution and stirred for 10 min at 60° C. The resultant yellow precipitate was filtered and dried at 110° C. for 3 hours. Finally, the product was rinsed with tetrahydrofuran (THF) and dried at 60° C. for 24 hours.

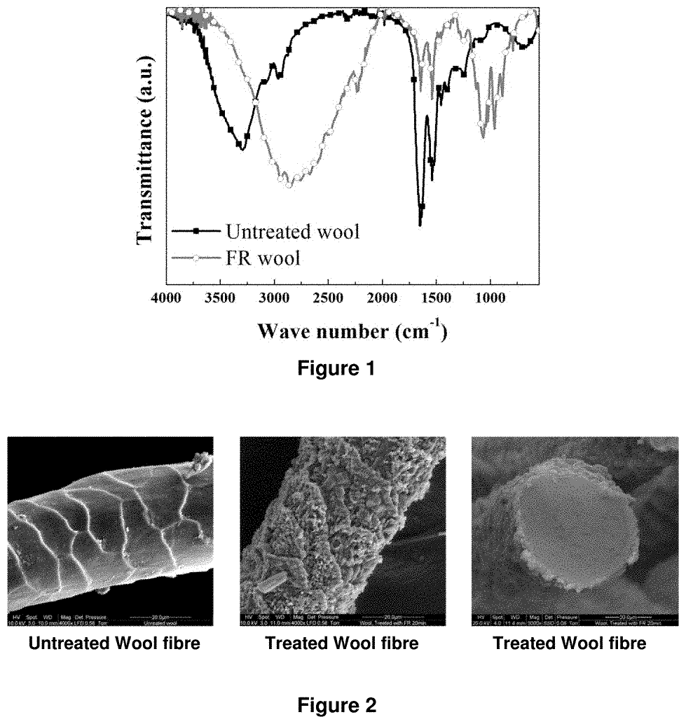

Fourier transform infrared spectroscopy (FT-IR) was carried out to confirm that the ethylenediamine phosphate (EDAP) and pentaerythritol (PER) were successfully combined with wool fibre. The results are shown in FIG. 1. The newly appeared peaks at 1014, 1050 and 2850 cm−1 ascribed to P═O, C—OH and N—H groups, respectively, indicate the presence of the EDAP and PER.

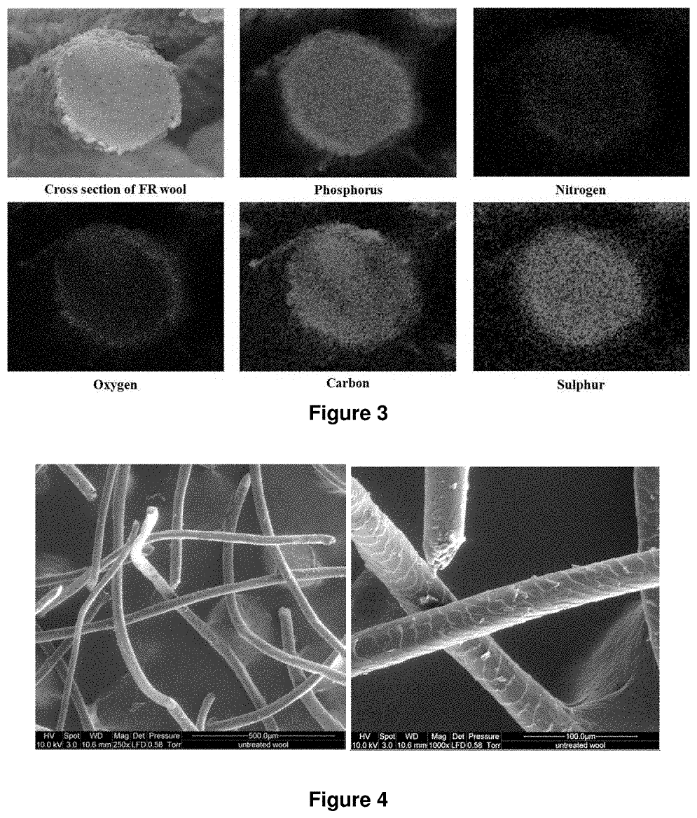

The treated flame retardant (FR) wool was analysed and compared to the untreated wool using SEM (Scanning Electron Microscopy) with EDS (Energy-dispersive X-ray spectroscopy). FIG. 2 shows images comparing of the fibres of the untreated wool and treated wool. FIG. 3 shows the distribution of phosphorus, nitrogen, oxygen, carbon and sulphur through a cross section of treated wool fibre. It is particularly noted phosphorus is substantially distributed throughout the cross section of the treated wool fibre. An elemental analysis comparing the untreated and treated wool is also shown in Table 1.

TABLE 1

| | Untreated wool | Treated wool |
|---|---|---|
| Element | (wt %) | (wt %) |
| Phosphorus | 0 | 15.38 |
| Oxygen | 13.19 | 28.24 |
| Nitrogen | 10.89 | 8.68 |
| Carbon | 71.46 | 46.57 |
| Sulphur | 4.46 | 1.13 |
| Total | 100 | 100 |

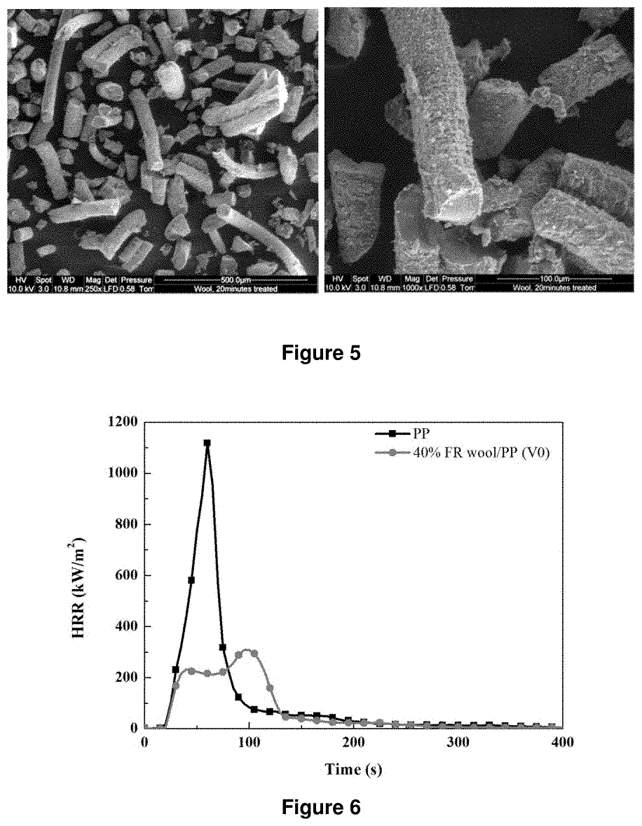

FIGS. 4 and 5 also compare the length and texture of the untreated and treated wool fibres. The untreated wool is shown in FIG. 4 for comparison with the treated wool fibres in FIG. 5.

### Example 1.2

The IFR wool of the invention produced in Example 1.1 was then melt-blended with polypropylene (PP) (ICORENE K515, polypropylene copolymer for rotational moulding) and maleic anhydride grafted polypropylene (MAPP Licocene 6452 from Clariant Ltd) at 170° C. for 3 min at a speed of 50 rpm in a Brabender mixer. The composite of the invention was then prepared using a hot press at 175° C.

The flame retardant effect of the intumescent flame retardant (IFR) wool of the invention on a IFR/polypropylene composite was investigated using a cone calorimeter. The results are shown in Figure. 6.

A 72% reduction in peak heat release rate compared to that of pure polypropylene (PP) was substantially achieved by adding 40 wt % IFR wool of the invention, i.e. treated wool/polypropylene composite with 40 wt % treated wool. Although the composite contains maleic anhydride grafted polypropylene (MAPP), compared to pure polypropylene, it is believed the effect of MAPP on the composite flammability would not be significant.

Further experiments were carried out using a cone calorimeter to compare the flame retardancy of:
1. pure polypropylene (PP)—(comparative example);
2. 40% untreated wool/polypropylene composite (wool/PP)—(comparative example);
3. 40% treated wool/polypropylene/maleic anhydride grafted polypropylene composite (FR wool/PP)—(composite of the invention);
4. 20% Ammonium Polyphosphate (APP)/polypropylene composite (APP/PP) —(comparative example). Ammonium Polyphosphate (APP) is a commercially available flame retardant

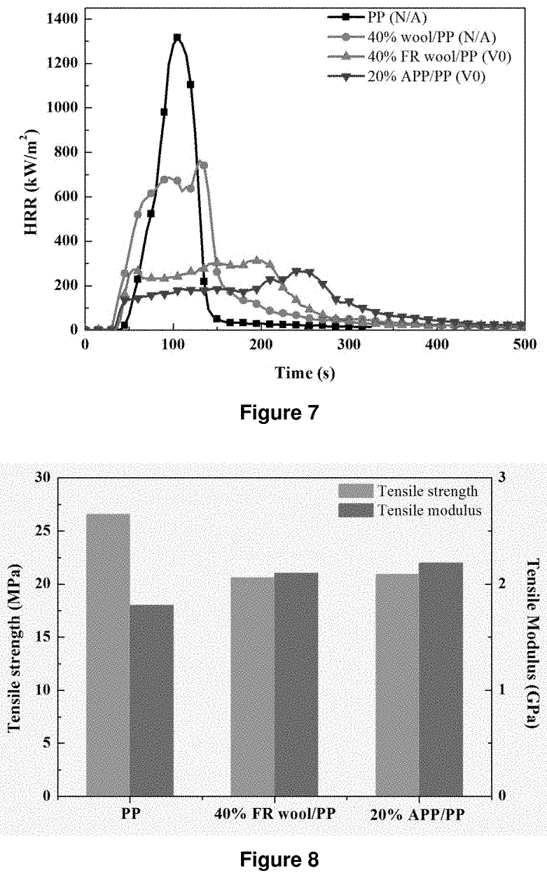

The results are shown in FIG. 7. The results show the natural flame retardant properties of wool (untreated) reduce the peak heat release rate (HRR), but that when treated wool of the invention is used in a composite the peak heat release rate is reduced still further such that it is comparable with a composite made with a commercial flame retardant. The composite of the invention (and the composite with the commercially available flame retardant (Ammonium Polyphosphate)) achieved V-0 classification in UL 94, the Standard for Safety of Flammability of Plastic Materials for Parts in Devices and Appliances testing and 76% reduced peak heat release rate (HRR) compared to pure polypropylene.

It is noted that there is a difference in the peak HRR rate for polypropylene between FIGS. 6 and 7. The inventors have found that ˜±10% deviation between tests is common.

The mechanical properties (tensile strength in MPa and tensile modulus in GPa) of the pure polypropylene and composite of the invention and Ammonium Polyphosphate (APP)/polypropylene composite were also tested using the ASTM D638 testing procedure. The results are shown in FIG. 8

### Example 2.1

The procedure used in Example 1.1 was repeated using two different concentrations of sulphuric acid. A precipitates were obtained. The results are shown in Table 2 below.

### Example 3.1

The procedure used in Example 1.1 was repeated modifying the concentrations of the aqueous ethylenediamine and/or the aqueous phosphoric acid solutions.

The treated wool produced was less brittle when lower concentrations ethylenediamine were used. It is also believed the flexibility of the treated wool could be modified by using different reactive amines.

This example shows the flexibility of the treated wool product can be modified by making minor modifications to the treatment conditions. It is also believed modification of the treatment conditions will modify the flame retardancy properties.

TABLE 2

| | | | | | | | #7 | |
|---|---|---|---|---|---|---|---|---|
| | | | | | | | (Example | |
| Test number | #1 | #2 | #3 | #4 | #5 | #6 | 1.1) | #8 |
| Ethylenediamine | 23 | 23 | 30 | 30 | 30 | 30 | 30 | 30 |
| concentration | | | | | | | | |
| (wt %) | | | | | | | | |
| Phosphoric acid | 15 | 18 | 13 | — | 15 | — | 18 | 20 |
| concentration | | | | | | | | |
| (wt %) | | | | | | | | |
| Sulphuric acid | — | — | — | 13 | — | 15 | — | — |
| concentration | | | | | | | | |
| (wt %) | | | | | | | | |
| Brittleness of | flexible | flexible | brittle | brittle | brittle | brittle | brittle | brittle |
| treated wool | | | | | | | | |

### Example 4.1

The procedure used in Example 1.1 was repeated using 6 wt % melamine solution and 23 wt % phosphoric acid in place of 30 wt % aqueous ethylenediamine solution and 18 wt % phosphoric acid.

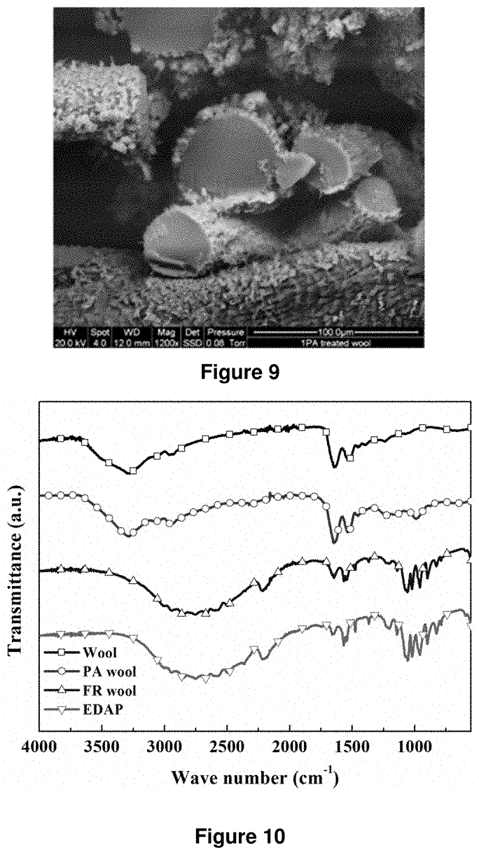

A SEM image of the treated wool fibre is shown in FIG. 9. An elemental analysis of the treated wool fibre is shown in Table 3. It is noted the phosphorus content is higher in the fibres treated with melamine/phosphoric acid/pentaerythritol than when treated with ethylenediamine/phosphoric acid/pentaerythritol (compare Table 1).

TABLE 3

| | Treated wool |
|---|---|
| Element | (wt %) |
| Phosphorus | 23.06 |
| Oxygen | 21.71 |
| Nitrogen | 9.28 |
| Carbon | 44.36 |
| Sulphur | 1.6 |
| Total | 100 |

### Example 5

Materials

Scoured coarse wool fibres were provided by Bloch & Behren Ltd., New Zealand. Phosphoric acid (conc.: 85 wt % in H₂O), ethylenediamine and toluene were obtained from Sigma-Aldrich and used without any further purification. Polypropylene (PP) (K515, MFI: 19) was purchased from A. Schulman, Inc. Maleic anhydride grafted polypropylene (MA-g-PP) Licocene 6452 was provided by Clariant Ltd., New Zealand to be used as a compatibiliser.

Synthesis of Flame Retardant Wool Fibre

Chopped coarse wool fibre (mean fibre length: 2.4 mm) was immersed in various concentrations of phosphoric acid (PA)/water solution for 10 min at room temperature, then vacuum filtered and dried at 110° C. for 30 min. The phosphoric acid treated wool fibre was then immersed in ethylenediamine (EDA)/toluene solution with different concentrations for 30 min at 80° C. to prepare an ethylenediamine phosphate (EDAP) and phosphoric acid (PA) implanted wool fibre. The resultant precipitate was filtered and dried at 110° C. for 30 min to remove the unreacted ethylenediamine.

Fabrication of Flame Retardant Wool Fibre/Polypropylene (PP) Composite

The flame retardant wool fibre (FR wool) was melt-blended with polypropylene in the presence of 5 wt % of maleic anhydride grafted polypropylene (MA-g-PP) at 170° C. for 3 min at a speed of 70 rpm with an internal mixer (W 50 EHT, Brabender GmbH & Co, Germany) to obtain a 40% FR wool/polypropylene composite. The composites obtained were pelletised and then hot pressed into sheets at 175° C. for further characterization.

Characterisation

Fourier transform infrared spectroscopy (FT-IR, Nicolet 6700 spectrometer, Thermo Electron Corp., USA) was used to investigate the surface functional groups of the modified wool fibres. The thermal property of untreated and treated fibre was measured with a thermo gravimetric analyser (TGA, Q50, TA Instruments, USA). Approximately 5 mg of each sample was tested in an air atmosphere, from room temperature to 850° C., with a heating rate of 10° C. min⁻¹. The morphology observation and elemental analysis of the fibres were carried out by field emission environmental scanning electron microscope (SEM, Quanta 200, FEI, USA) with energy-dispersive X-ray spectroscopy (EDS, EDAX Pegasus EDS detector, AMETEK. INC., USA).

Flammability Test of Flame Retardant (FR) Wool/Polypropylene Composite

Vertical burning test was performed according to ASTM D3801 (equivalent to UL-94 standard). Samples of 125 mm×13 mm×2.4 mm dimensions were prepared and preconditioned under 23° C. and 50% relative humidity for 48 h. The test results were classified into different grades, V-0, V-1, V-2 or No rating (NR). In addition, cone calorimeter (Fire Test Technology, East Grinstead, UK) was used to measure the fire behaviour in the condensed phase according to ASTM E1354. Samples of 100 mm×100 mm×2.4 mm were tested in a horizontal position with an external heat flux of 50 kW/m².

Results and Discussion

Flame Retardant Material

FIG. 10 shows Fourier transform infrared spectroscopy (FT-IR) spectra of untreated wool (wool), phosphoric acid (32%) treated wool (PA wool), flame retardant wool of the invention (FR wool—treated with phosphoric acid then ethylenediamine in a molar ratio of 3.6 EDA/PA), and ethylenediamine phosphate (EDAP) for comparison to the FR wool. After the phosphoric acid (PA) treatment, newly appeared P═O and P—O peak at 1129 cm⁻¹ and 990 cm⁻¹, respectively, showed the phosphoric acid absorption to the wool fibre. After the ethylenediamine treatment of the PA wool, the P—O peak shifted to 1014 cm⁻¹ and new peaks appeared at 2753-2495 cm⁻¹ ascribed to NH₃⁺ group. It is believed these changes along with the similarity to the spectrum for EDAP indicate the formation of the ethylenediamine phosphate (EDAP) on the wool fibre.

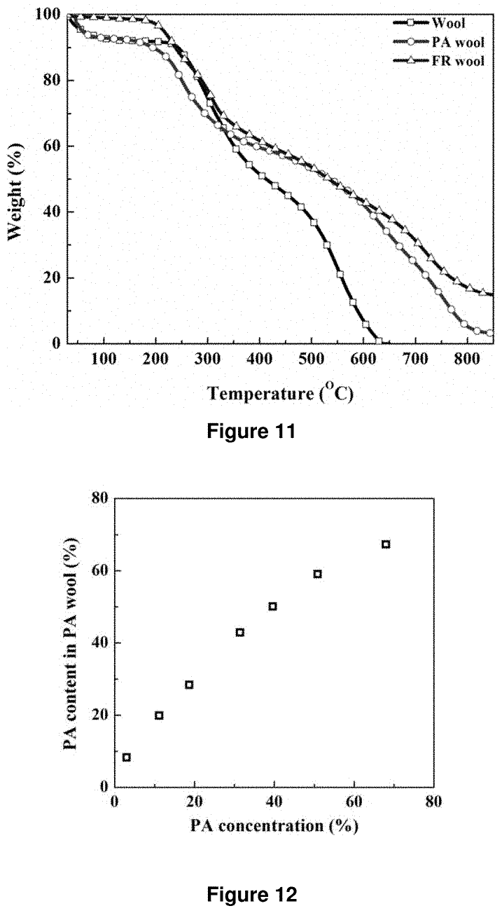

FIG. 11 shows the thermo gravimetric analyser (TGA) curves of untreated wool fibre (wool), phosphoric acid (32%) treated wool (PA wool) and flame retardant wool of the invention (FR wool—treated with phosphoric acid then ethylenediamine in a molar ratio of 3.6 EDA/PA) obtained in an air atmosphere. This shows in spite of the two-stage char formation initiated at 189° C. and 465° C., untreated wool fibre was completely decomposed below 650° C. After the phosphoric acid treatment (PA wool), onset of the first decomposition decreases from about 189° C. to about 126° C. It is believed the absorbed phosphoric acid accelerated the decomposition of the fibre. A rapid char formation follows between about 126-420° C. and a further decomposition ensued at a considerably reduced decomposition rate, which resulted in 3.2 wt % residue at 850° C. After the ethylenediamine treatment (FR wool), the initial decomposition temperature of the flame retardant wool increases from 126° C. to 161° C. along with a further reduced decomposition rate which made the final char residue increase to 14.8 wt %.

In addition, the treatments also influence the moisture absorption property of the fibre. While the phosphoric acid treated wool reported about 8 wt % loss at the temperature range, the FR wool shows below 2 wt % loss in spite of the equal phosphorus content compared to the phosphoric acid treated wool.

The dried samples showed a colour change in the wool fibre. The wool fibre turned reddish yellow after the phosphoric acid treatment. It is believed this was due to thermal degradation. After the ethylenediamine treatment the colour change reversed back to white yellow similar to the original wool fibre. It is believed this is due to the ethylenediamine phosphate coating the outside of the wool fibre.

FIG. 12 shows a plot of content of phosphoric acid (PA) in PA treated wool as a function of the concentration of the phosphoric acid used. The content of PA in the wool was measured by weighing the wool before and after treatment to calculate the weight percentage of phosphoric acid incorporated in the wool.

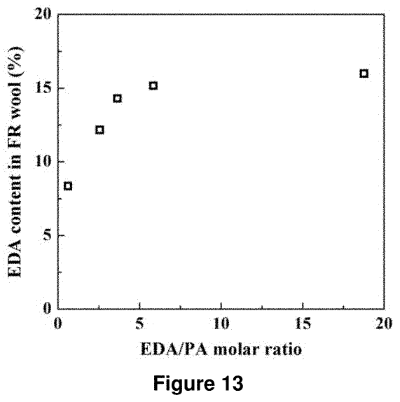

FIG. 13 shows the content of ethylenediamine in flame retardant wool of the invention. The wool was treated using 32% phosphoric acid (PA) followed by various concentrations of ethylaminediamine (EDA). The various concentrations were selected based on the measured content of PA in the wool then various calculated molar ratios of EDA used for treatment.

The phosphoric acid absorption rate appears to increase significantly at the lower end of the phosphoric acid concentrations used but gradually plateaus as the phosphoric acid concentration increases (FIG. 12). Among various factors affecting the phosphoric acid absorption, the concentration of phosphoric acid solution appears to dominantly affected the phosphoric acid absorption by the wool fibre, while treatment temperature or treatment time have lesser affects in the experiments performed by the inventors.

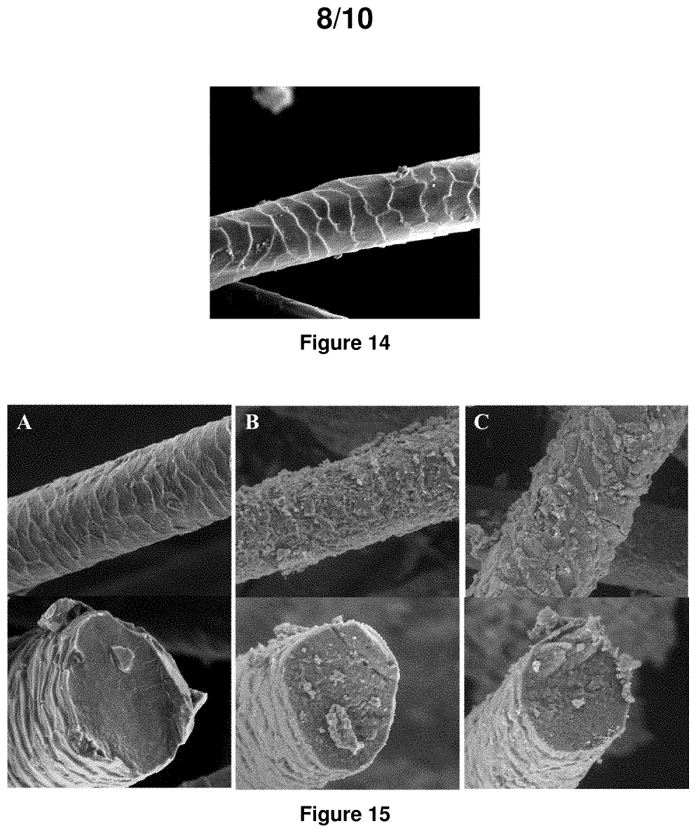

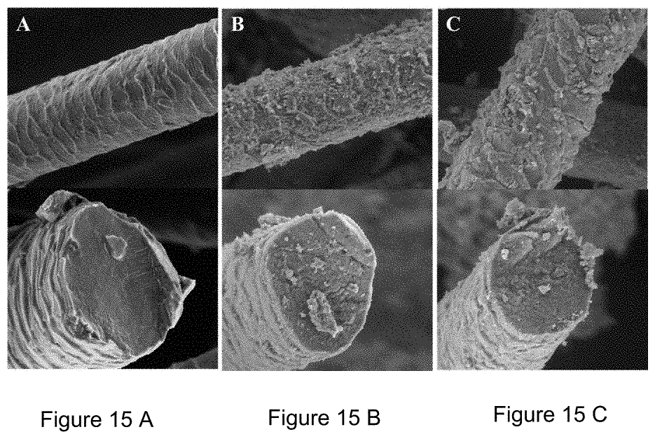

FIGS. 14 and 15 show SEM images of the surface and cross section of wool fibres. FIG. 14 shows untreated wool for comparison. FIG. 15A shows wool treated with 32% phosphoric acid. FIG. 15B shows wool fibre treated with 32% phosphoric acid and followed by ethylenediamine (EDA) in a 3.6 EDA/PA molar ratio. FIG. 15C shows wool fibre treated with 32% phosphoric acid followed by ethylenediamine (EDA) in a 18.8 EDA/PA molar ratio.

After the phosphoric acid treatment in 32% phosphoric acid aqueous solution, the shape of the wool fibre was changed from the untreated state (FIG. 14) to be more smooth and swelled (FIG. 15A). After the 32% phosphoric acid solution treatment, the treated wool fibre showed a 43% weight increase. It is believed that 43% of phosphoric acid was absorbed into the fibre.

This assumption is based on minimal weight loss of the wool fibre during the treatment confirmed by the SEM image (FIG. 15A).

Ethylenediamine treatment on the phosphoric acid treated wool appears to have a significant effect on the physical properties of the wool. It is believed an EDAP layer develops on the outer layer of the fibre in the early stage of reaction with EDA which may reduce further ethylenediamine loading (see FIGS. 15B and 15C). However, despite this it was shown more ethylenediamine combines with the fibre at a higher ethylenediamine concentration when using equal treatment times (see FIG. 13).

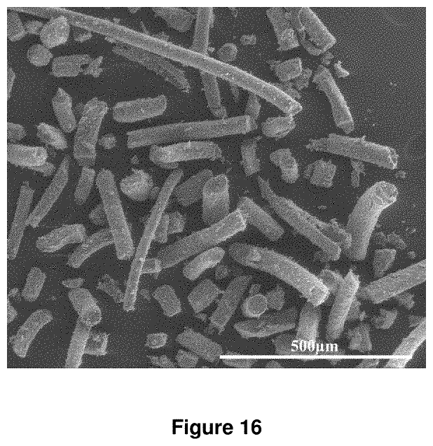

After the ethylenediamine treatment, the core of the fibre shows significantly different morphology (FIGS. 15B and 15C). It is observed to be more brittle compared to phosphoric acid treated wool (FIG. 15A). It is believed alkali treatment of wool fibre may destroy the disulphide linkage which bind the protein constituents in a wool fibre, and hence releases the proteins from the bonds. It is believed this could be the reason the flame retardant wool wool made by the process of the invention can be weak and stiff against external force. The inventors have shown use of higher concentrations of reactive amine (for example EDA) results in a more brittle flame retardant material. For example, the wool treated using 32% phosphoric acid followed by ethylenediamine solution with 18.8 EDA/PA molar ratio is more brittle than when 3.6 EDA/PA molar ratio was used, and can be pulverized to powder (see FIG. 16).

Polymer Composite

In order to evaluate the improved flame retardant performance of polypropylene (PP) after addition of the flame retardant material, vertical burning test and cone calorimeter test were conducted.

The following polymers/composites were tested and compared:
(A) pure polypropylene (PP)—comparison
(B) 40% untreated wool/polypropylene (PP)—comparison
(C) 40% treated (flame retardant—FR) wool/polypropylene (PP)—invention
(D) 20% APP/PP—comparison

The percentage of each constituent of the composite of the invention was calculated based on the phosphoric acid and ethylenediamine loading in the fibre after each treatment (see FIGS. 12 and 13). The composite (C) denoted as 40% treated wool/PP composite contained 15% ethylenediamine phosphate, 25% wool fibre with 5% remaining phosphoric acid. Samples of pure PP, 40% wool/PP composite and 20% APP/PP composite were prepared for comparison. The 20% APP/PP composite sample was added for comparison on the basis of the available literature stating that the normal dosage of APP for PP to achieve V-0 grade in vertical burning test is 20-25%.

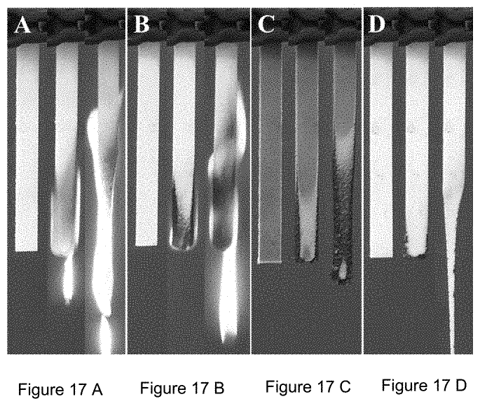

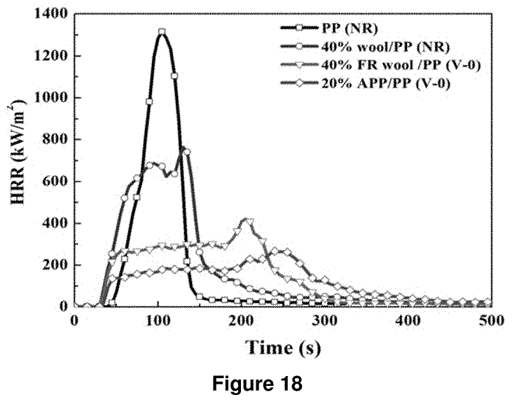

The results of the burning test are shown in FIG. 17. The captured images during the vertical burning test (FIG. 18—A to D) show the burning status of the samples at 0 sec, 10 sec and 20 sec after flame application. However, in the case of the samples which achieved the V-0 grade (Figures C and D), the image at 20 sec was replaced with an image after a complete fire extinction. This was to emphasise the different melt behaviour between 40% FR wool/PP composite of the invention and the 20% APP/PP composite. The 40% FR wool/PP composite of the invention (C) successfully achieved the V-0 grade without a drip owing to its rapid and solid char formation.

In order to further investigate the response of the samples against a consistent heat exposure, cone calorimeter test was performed. The results of the cone calorimeter test are shown in FIG. 18. The FR wool/PP composite of the invention (C) recorded 69% reduction of peak heat release rate (PHRR), compared to that of pure PP.

### CONCLUSIONS

Flame retardant material of the invention was successfully synthesised with a rapid and simple two step treatment process. Control of the percentages of the flame retardant constituents in the fibre was controlled using different concentrations of the inorganic acid (for example phosphoric acid) and the reactive amine (for example ethylenediamine). The composite of the invention had comparable flame retardant properties with a composite made with a commercial flame retardant. The composite of the invention (and the composite with the commercially available flame retardant (Ammonium Polyphosphate)) achieved V-0 classification in UL 94, the Standard for Safety of Flammability of Plastic Materials for Parts in Devices and Appliances testing.

The invention is further described by the following numbered paragraphs:

1. A method of making a flame retardant material, the method including the steps of:
(i) treating a keratinous fibre with a reactive amine; and
(ii) treating the fibre with an inorganic acid.

wherein step (i) and (ii) can be done in either order.

2. The method of paragraph 1 wherein step (ii) follows step (i).

3. The method of paragraph 1 wherein the keratinous fibre is wool, hair, feather or silk, preferably wool.

4. The method of any preceding paragraph wherein the reactive amine is selected from any one or more of: ammonia, C₁-C₂₀ alkylamines, amines with molecular mass between about 17-400 g/mol, preferably selected from ethylenediamine, melamine, hexadecylamine, octadecylamine, dodecylamine, ammonia, preferably ethylenediamine and/or melamine.

5. The method of any preceding paragraph wherein the reactive amine is in solution, preferably in an aqueous solution.

6. The method of paragraph 6 wherein the reactive amine is ethylenediamine and the aqueous solution contains about 5 to 80% by weight, preferably about 10 to 60% by weight, preferably about 15 to 50% by weight.

7. The method of paragraph 6 wherein the reactive amine is melamine and the aqueous solution contains about 1 to 30% by weight melamine, preferably about 1 to 20% by weight, preferably about 1 to 15% by weight.

8. The method of any preceding paragraph wherein step (i) is at pH greater than 8, preferably about 10 to 14.

9. The method of any preceding paragraph wherein the keratinous fibre in step (i) is immersed in a solution of the reactive amine for between about 5 minutes to 2 hours, preferably for between about 10 minutes to 1 hour, preferably between about 10 minutes to 40 minutes.

10. The method of paragraph 9 wherein the solution is warmed above room temperature, preferably warmed to between about 35° C. and 60° C., preferably about 50° C.

11. The method of any one of paragraphs 5 to 10 dependent on paragraph 5 wherein the fibre is removed from the reactive amine solution by filtration,

12. The method of any preceding paragraph wherein the fibre is dried after step (i).

13. The method of any preceding paragraph wherein the inorganic acid provides a phosphate ion source, preferably the inorganic acid is selected from phosphoric acid, pyrophosphoric acid and/or polyphosphoric acid, preferably the inorganic acid is phosphoric acid.

14. The method of any one of paragraphs 1 to 12 wherein the inorganic acid is sulphur based, preferably the inorganic acid provides a sulphate ion source, preferably the inorganic acid is sulphuric acid.

15. The method of any preceding paragraph wherein the inorganic acid is in aqueous solution.

16. The method of paragraph 15 wherein the inorganic acid solution contains about 1 to about 50% by weight inorganic acid.

17. The method of any one of paragraphs 1 to 13 wherein the inorganic acid is phosphoric acid the aqueous solution contains about 1 to 50% by weight phosphoric acid, preferably about 5 to 40% by weight, preferably about 10 to 30% by weight.

18. The method of any one of paragraphs 1 to 12 or 14 wherein the inorganic acid is sulphuric acid the aqueous solution contains about 1 to 30% by weight sulphuric acid, preferably about 5 to 40% by weight, preferably about 10 to 25% by weight.

19. The method of any one of paragraphs 15 to 18 wherein the keratinous fibre is immersed in the inorganic acid solution for between about 1 minute to 1 hour, preferably for between about 2 minutes to 40 minutes, preferably between about 5 minutes to 30 minutes, preferably about 10 minutes.

20. The method of paragraph 15 wherein the inorganic acid and keratinous fibre are warmed above room temperature, preferably between about 35° C. and 80° C., preferably about 60° C.

21. The method of any one of paragraphs 15 to 20 wherein the fibre is removed from the inorganic acid solution by filtration. Preferably the fibre is dried. Preferably the fibre is rinsed with a solvent.

22. The method of any preceding paragraph wherein the fibre is also treated with a char forming agent, preferably the char forming agent is added in step (ii), preferably the char forming agent is selected from a polyol, preferably the char forming agent is selected from pentaerythritol monomer, pentaerythritol dimer, pentaerythritol trimer, a phenol-formaldehyde resin, methylol melamine, starch, dextrin, sorbitol, preferably the char forming agent is pentaerythritol monomer.

23. The method of any preceding paragraph wherein the method further includes the step of combining at least one synthetic polymer with the fibre followings steps (i) and (ii) to form a composite material.

24. A flame retardant material produced by the method of any one of paragraphs 1 to 23.

25. A flame retardant material including:
keratinous fibre including between 1 and 40% by weight above natural levels of phosphorus or sulphur;
wherein the phosphorus or sulphur is distributed throughout the cross section of the keratinous fibre.

26. The flame retardant material of paragraph 25 wherein the phosphorus or sulphur is substantially evenly distributed throughout the cross section of the keratinous fibre.

27. The flame retardant material of paragraph 25 or 26 wherein the keratinous fibre includes between about 1 and 40% by weight phosphorus, preferably the keratinous fibre includes between about 1 and 30% by weight phosphorus, preferably between about 1 and 25% by weight phosphorus, preferably between about 15 and 25% by weight phosphorus.

28. The flame retardant material of any one of paragraphs 25 to 27 wherein at least a portion of the phosphorus is in the form of an amine phosphate.

29. The flame retardant material of paragraphs 25 or 26 wherein keratinous fibre includes between about 5 and 40% by weight sulphur, preferably between about 15 and 25% sulphur.

30. The flame retardant material of any one of paragraphs 25 to 29 wherein the keratinous fibre is wool, hair, feather or silk, preferably wool.

31. The flame retardant material of any one of paragraphs 25 to 29 wherein the fibre includes a char forming agent, preferably the char forming agent is a polyol, preferably the char forming agent is selected from pentaerythritol monomer, pentaerythritol dimer, pentaerythritol trimer, a phenol-formaldehyde resin, methylol melamine, starch, dextrin, sorbitol, preferably the char forming agent is a pentaerythritol monomer.

32. A method of making a polymer composite, the method including the steps:
(i) treating a keratinous fibre with a reactive amine; and
(ii) treating the fibre with an inorganic acid;
(iii) combining at least one synthetic polymer with the fibre.

wherein step (i) and (ii) can be done in either order then followed by step (iii).

33. The method of paragraph 32 wherein step (ii) follows step (i).

34. The method of paragraph 32 or 33 wherein the keratinous fibre is wool, hair, feather or silk, preferably wool.

35. The method of any one of paragraphs 32 to 34 wherein the reactive amine is selected from any one or more of: ammonia, C₁-C₂₀ alkylamines, amines with molecular mass between about 17-400, preferably the reactive amine is selected from any one or more of: ethylenediamine, melamine, hexadecylamine, octadecylamine, dodecylamine, ammonia, preferably ethylenediamine and/or melamine.

36. The method of any one of paragraphs 32 to 35 wherein the reactive amine is in solution, preferably in an aqueous solution.

37. The method of paragraph 36 wherein the reactive amine is ethylenediamine and the aqueous solution contains about 5 to 80% by weight, preferably about 10 to 60% by weight, preferably about 15 to 50% by weight.

38. The method of paragraph 36 wherein the reactive amine is melamine and the aqueous solution contains about 1 to 30% by weight melamine, preferably about 1 to 20% by weight, preferably about 1 to 15% by weight.

39. The method of any one of paragraphs 32 to 38 wherein step (i) is at pH greater than 8, preferably about 10 to 14.

40. The method of any one of paragraphs 36 to 39 wherein the keratinous fibre in step (i) is immersed in a solution of the reactive amine for between about 5 minutes to 2 hours, preferably for between about 10 minutes to 1 hour, preferably between about 10 minutes to 40 minutes.

41. The method of any one of paragraphs 36 to 40 wherein the solution is warmed above room temperature, preferably warmed to between about 35° C. and 60° C., preferably about 50° C.

42. The method of any one of paragraphs 36 to 41 wherein the fibre is removed from the reactive amine solution by filtration.

43. The method of any one of paragraphs 32 to 42 wherein preferably the fibre is dried after step (i).

44. The method of any one of paragraphs 32 to 43 wherein the inorganic acid provides a phosphate ion source, preferably the inorganic acid is selected from phosphoric acid, pyrophosphoric acid and/or polyphosphoric acid, preferably the inorganic acid is phosphoric acid.

45. The method of any one of paragraphs 32 to 43 wherein the inorganic acid is sulphur based, preferably the inorganic acid provides a sulphate ion source, preferably the inorganic acid is sulphuric acid.

46. The method of any one of paragraphs 32 to 45 wherein the inorganic acid is in aqueous solution.

47. The method of paragraph 46 wherein the inorganic acid solution contains about 1 to about 50% by weight inorganic acid.

48. The method of any one of paragraphs 32 to 47 wherein the keratinous fibre is immersed in the inorganic acid solution for between about 1 minute to 1 hour, preferably for between about 2 minutes to 40 minutes, preferably between about 5 minutes to 30 minutes, preferably about 10 minutes.

49. The method of paragraph 48 wherein the inorganic acid and keratinous fibre are warmed above room temperature, preferably between about 35° C. and 80° C., preferably about 60° C.

50. The method of any one of paragraphs 46 to 49 wherein the fibre is removed from the inorganic acid solution by filtration, preferably the fibre is dried, preferably the fibre is rinsed with a solvent.

51. The method of any one of paragraphs 32 to 50 wherein the fibre is also treated with a char forming agent, preferably the char forming agent is added in step (ii), preferably the char forming agent is selected from a polyol, preferably the char forming agent is selected from pentaerythritol monomer, pentaerythritol dimer, pentaerythritol trimer, a phenol-formaldehyde resin, methylol melamine, starch, dextrin, sorbitol, preferably the char forming agent is a pentaerythritol monomer.

52. The method of any one of paragraphs 32 to 51 wherein the synthetic polymer and the fibre are combined in step (iii) by mixing and/or blending and/or melting.

53. The method of any one of paragraphs 32 to 52 wherein the fibre is pulverised prior to step (iii).

54. The method of any one of paragraphs 32 to 53 wherein the synthetic polymer is a thermoset or a thermoplastic polymer.

55. The method of any one of paragraphs 32 to 54 wherein in step (iii) about 1 to 80% by weight keratinous fibre is combined with about 20 to 99% by weight synthetic polymer, preferably between about 1 and 60% by weight fibre with about 40 to 99% by weight synthetic polymer, preferably between about 10 and 60% by weight fibre with about 40 to 90% by weight synthetic polymer.

56. The method of any one of paragraphs 32 to 55 wherein following step (iii) the polymer composite is formed into a desired shape.

57. The method of any one of paragraphs 32 to 56 wherein one or more additional components are added in step (iii), preferably a compatibilizer and/or reinforcement.

58. A polymer composite produced by the method of any one of paragraphs 32 to 57.

59. A polymer composite including:
a keratinous fibre,
at least one synthetic polymer,

wherein the keratinous fibre includes between about 1 and 40% by weight above natural levels of phosphorus or sulphur;

wherein the phosphorus or sulphur is distributed throughout the cross section of the keratinous fibre.

60. The polymer composite of paragraph 59 wherein the phosphorus or sulphur is substantially evenly distributed throughout the cross section of the keratinous fibre.

61. The polymer composite of paragraph 59 or 60 wherein the keratinous fibre includes between about 1 and 30% by weight phosphorus, preferably between about 1 and 25% by weight phosphorus, preferably between about 15 and 25% by weight phosphorus.

62. The polymer composite of any one of paragraphs 59 to 61 wherein at least a portion of the phosphorus is in the form of an amine phosphate.

63. The polymer composite of paragraph 59 or 60 wherein the keratinous fibre includes between 5 and 40% by weight sulphur.

64. The polymer composite of any one of paragraphs 59 to 63 wherein the keratinous fibre is wool, hair, feather or silk, preferably wool.

65. The polymer composite of any one of paragraphs 59 to 64 wherein the fibre includes a char forming agent, preferably the char forming agent is a polyol, preferably the char forming agent is selected from pentaerythritol monomer, pentaerythritol dimer, pentaerythritol trimer, a phenol-formaldehyde resin, methylol melamine, starch, dextrin, sorbitol, preferably the char forming agent is pentaerythritol monomer.

66. The polymer composite of any one of paragraphs 59 to 65 wherein the synthetic polymer is a thermoset or a thermoplastic.

67. The polymer composite of any one of paragraphs 59 to 66 wherein the composite includes about 1 to 80% by weight keratinous fibre, preferably between about 1 and 60% by weight, preferably between about 10 and 60% by weight.

68. The polymer composite of any one of paragraphs 59 to 67 wherein the composite includes about 1 to 80% by weight keratinous fibre combined with about 20 to 99 to 20% by weight synthetic polymer, preferably between about 1 and 60% by weight fibre with about 40 to 99 to 40% by weight synthetic polymer, preferably between about 10 and 60% by weight fibre with about 40 to 90 to 40% by weight synthetic polymer.

1. A method of making a flame retardant material, the method including the steps of:
(i) treating a keratinous fibre with a reactive amine; and
(ii) treating the fibre with an inorganic acid.
wherein step (i) and (ii) can be done in either order.

2. The method of claim 1 wherein the keratinous fibre is wool.

3. The method of claim 1 wherein the reactive amine is selected from any one or more of: ammonia, C₁-C₂₀ alkylamines, amines with molecular mass between about 17-400 g/mol.

4. The method of claim 1 wherein the reactive amine is selected from ethylenediamine, melamine, hexadecylamine, octadecylamine, dodecylamine, ammonia.

5. The method of claim 1 wherein the reactive amine is in solution containing about 5 to 80% by weight reactive amine.

6. The method of claim 1 wherein the keratinous fibre in step (i) is immersed in the reactive amine for between about 5 minutes to 2 hours.

7. (canceled)

8. The method of claim 1 wherein the inorganic acid provides a phosphate ion source or is sulphur based.

9. The method of claim 1 wherein the inorganic acid is in aqueous solution.

10. The method of claim 9 wherein the inorganic acid solution contains about 1 to about 50% by weight inorganic acid.

11. The method of claim 1 wherein the keratinous fibre is immersed in the inorganic acid for between about 1 minute to 1 hour,

12. The method of claim 1 wherein the fibre is also treated with a char forming agent.

13. The method of claim 1 wherein the method further includes a step (iii) of combining at least one synthetic polymer with the fibre followings steps (i) and (ii) to form a composite material.

14. A flame retardant material including:
keratinous fibre including between about 1 and 40% by weight above natural levels of phosphorus or sulphur.

15. The flame retardant material of claim 14 wherein the phosphorus or sulphur is substantially distributed throughout the cross section of the keratinous fibre.

16. The flame retardant material of claim 14 wherein the phosphorus or sulphur is substantially evenly distributed throughout the cross section of the keratinous fibre.

17. (canceled)

18. The flame retardant material of claim 14 wherein at least a portion of the phosphorus is in the form of an amine phosphate.

19-20. (canceled)

21. The method of claim 13 wherein the synthetic polymer and the fibre are combined in step (iii) by mixing and/or blending and/or melting.

22. The method of claim 13 wherein the fibre is pulverised prior to step (iii).

23. The method of claim 13 wherein in step (iii) about 1 to 60% by weight keratinous fibre is combined with about 40 to 99% by weight synthetic polymer.

24. (canceled)

25. A polymer composite including:
a keratinous fibre,
at least one synthetic polymer,
wherein the keratinous fibre includes between about 1 and 40% by weight phosphorus or between about 1 and 40% by weight sulphur.

26. (canceled)
